(19) United States
(12) Patent Application Publication
(10) Pub. No.: US 2021/0154827 A1
(43) Pub. Date: May 27, 2021

(54) System and Method for Assisting a Visually Impaired Individual

(71) Applicant: Jeong Hun Kim, Baltimore, MD (US)

(72) Inventor: Jeong Hun Kim, Baltimore, MD (US)

(21) Appl. No.: 16/694,977

(22) Filed: Nov. 25, 2019

(51) Int. Cl. B25J 9/00; B25J 9/16; G01C 21/36

(52) U.S. Cl. CPC B25J 9/0003; G01C 21/3608; B25J 9/1694; B25J 9/1666

(57) ABSTRACT

A system and method for assisting a visually impaired individual provides a guide robot that can guide a user to a desired destination. The guide robot includes at least one camera device, at least one distance measurement device, a global positioning system (GPS) module, and a controller. The camera device, the distance measurement device, and the GPS module are used to capture data of the area surrounding the guide robot in order to track and detect path obstacles along an intended geospatial path. The intended geospatial path is virtually generated in accordance to a set of navigational instructions that can be provided by the user. The user can provide the navigational instructions through a set of voice commands and/or through a computerized leash. The guide robot can notify the user of the path obstacles along the intended geospatial in order to safely guide the user to the desired destination.

### FIELD OF THE INVENTION

The present invention relates generally to robotic assisting systems. More specifically, the present invention is a system and method for assisting a visually impaired individual. The present invention provides a robot that can guide a visually impaired individual when traveling alone.

### BACKGROUND OF THE INVENTION

Vision impairment or vision loss is a decrease in the ability to see that cannot be corrected with the use of vision correcting devices. Hence, an individual, with visual impairment or vision loss, will struggle to safely travel alone. For example, there are many obstacles that can be experienced during travel such as traffic, slippery roads, or other unexpected obstacles. Without the ability to see clearly or at all, a visually impaired individual is prone to be harmed by obstacles when traveling alone. There are various methods which can aid a visually impaired individual to travel alone. A popular and successful method is the use of a service dog. A service dog can aid a visually impaired individual by guiding them to a desired destination. Unfortunately, a service dog cannot directly communicate with the visually impaired individual and by aiding the visually impaired individual, the service dog can also be harmed by obstacles when traveling to a desired destination.

It is therefore an objective of the present invention to provide a system and method for assisting a visually impaired individual. The present invention replaces the use of service dogs by providing a robot that guide a visually impaired individual when traveling alone. The system of the present invention provides a guide robot that can track and detect environmental data in order to identify obstacles. Thus, the guide robot can warn a visually impaired individual of obstacles when traveling to a desired destination. Furthermore, the guide robot includes a global positioning system (GPS) module that allows the guide robot to generate virtual paths to the desired destination. A user can direct and control the guide robot through voice commands or a computerized leash.

### BRIEF DESCRIPTION OF THE DRAWINGS

FIG. 1 is a schematic diagram illustrating the overall system of the present invention.

FIG. 2A is a flowchart illustrating the overall method of the present invention.

FIG. 2B is a continuation of the flowchart from FIG. 2A.

FIG. 3 is a schematic diagram illustrating the exemplary system of the present invention.

FIG. 4 is a flowchart illustrating the subprocess that allows the user to input a set of vocal instructions as the set of navigational instructions.

FIG. 5 is a flowchart illustrating the subprocess that allows the user to remotely control the guide robot through the computerized leash.

FIG. 6 is a flowchart illustrating the subprocess that allows the user to remotely control the guide robot through the user interface device.

FIG. 7 is a flowchart illustrating the subprocess for movement of the guide robot dependent on traffic symbols.

FIG. 8 is a flowchart illustrating the subprocess that allows the emergency contact to be contacted in case of emergency.

FIG. 9 is a flowchart illustrating the subprocess that notifies the user of a known person detected by the guide robot.

FIG. 10 is a flowchart illustrating the subprocess that notifies the user of elevational changes.

FIG. 11 is a flowchart illustrating the subprocess that notifies the user of informational signs and/or menus.

FIG. 12 is a flowchart illustrating the subprocess that plans an exit path for the user to travel in case of emergency.

FIG. 13 is a flowchart illustrating the subprocess that notifies the user of a slippery surface.

FIG. 14 is a flowchart illustrating the subprocess that notifies the user when there is water present.

FIG. 15 is a flowchart illustrating the subprocess that gathers public transportation information.

FIG. 16 is a flowchart illustrating the subprocess that allows the user to activate the alarm device.

### DETAIL DESCRIPTIONS OF THE INVENTION

All illustrations of the drawings are for the purpose of describing selected versions of the present invention and are not intended to limit the scope of the present invention.

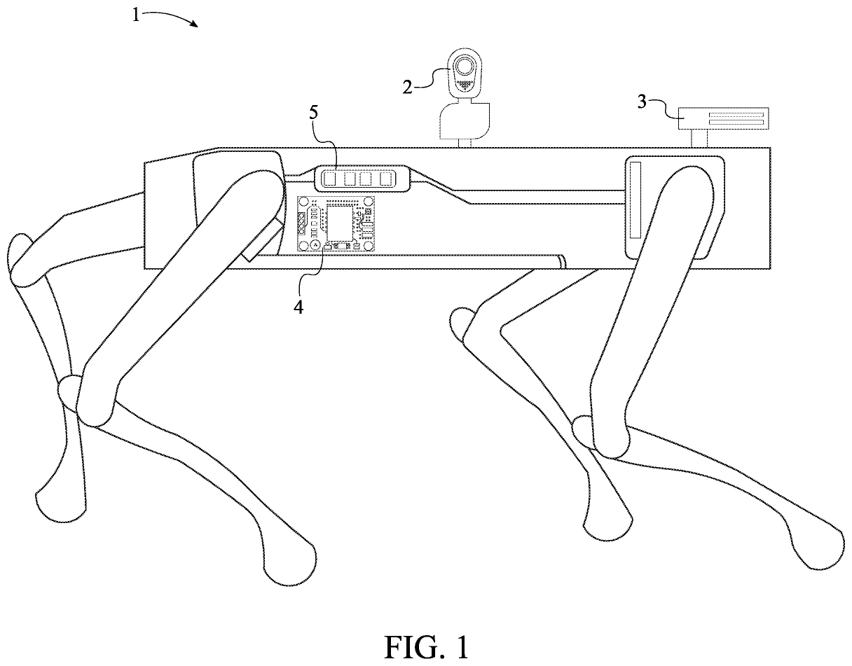

In reference to FIGS. 1 through 16, the present invention is a system and method for assisting a visually impaired individual by providing a robot that can guide a visually impaired individual. In further detail, the robot detects and captures data in order to safely guide a visually impaired individual when traveling alone. With reference to FIG. 1, the system of the present invention includes a guide robot 1 (Step A). The guide robot 1 is preferably a quadruped robot designed to resemble a canine. The guide robot 1 includes mechanical and electrical systems which allow the guide robot 1 to move about similarly to a quadruped animal. The guide robot 1 comprises at least one camera device 2, at least one distance measurement device 3, a global positioning system (GPS) module 4, and a controller 5. The camera device 2 may be any type of video-recording device able to capture images such as, but not limited to, a set of stereo cameras or a 360-degree camera. The distance measurement device 3 may be any device able to measure distance such as, but not limited to, an ultrasonic system or a lidar system. The GPS module 4 is a geolocation tracking device that is used to receive a signal from a GPS satellite in order to determine the guide robot's 1 geographic coordinates. The controller 5 is used to manage and control the electronic components of the guide robot 1.

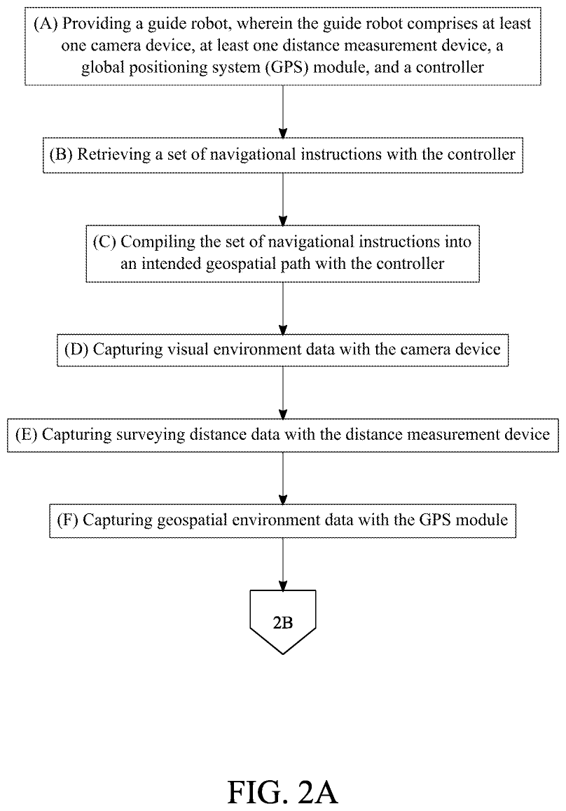

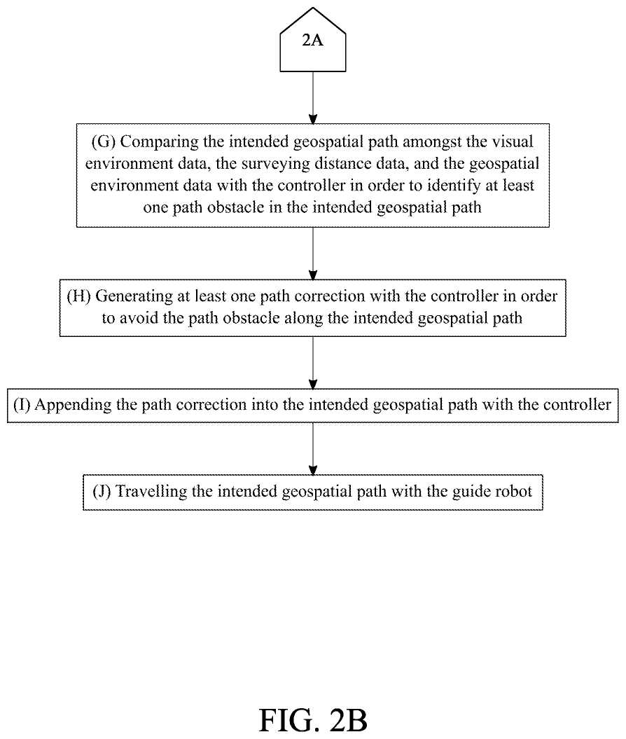

With reference to FIGS. 2A and 2B, the method of the present invention follows an overall process which allows the guide robot 1 to safely guide a visually impaired individual. The controller 5 retrieves a set of navigational instructions (Step B). The set of navigational instructions is a set of instructions inputted by a user. In further detail, the set of navigational instructions may be, but is not limited to, a specific address, and/or a set of voice commands inputted by the user. The controller 5 compiles the set of navigational instructions into an intended geospatial path (Step C). The intended geospatial path is a virtual path generated by the controller 5 which details how to reach a desired destination. The camera device 2 captures visual environment data (Step D). The visual environment data is a set of image frames representing the area surrounding the guide robot 1. The distance measurement device 3 captures surveying distance data (Step E). The surveying distance data is captured through the use of either reflected sound or light. The surveying distance data is used to generate a 3-D representation of the area surrounding the guide robot 1 in order to properly gauge the distance between the guide robot 1 and surrounding objects. The GPS module 4 captures geospatial environment data (Step F). The geospatial environment data is sent from a GPS satellite to the GPS module 4 in order to determine the geolocation of the guide robot 1. The controller 5 compares the intended geospatial path amongst the visual environment data, the surveying distance data, and the geospatial environment data in order to identify at least one path obstacle in the intended geospatial path (Step G). The path obstacle is any obstacle along the intended geospatial path which can prevent the guide robot 1 from reaching a desired destination or requires appropriate action such as, but not limited to, climbing a set of stairs. The controller 5 generates at least one path correction in order to avoid the path obstacle along the intended geospatial path (Step H). The path correction is an alternative route to a desired destination which avoids the path obstacle and/or is a modification in the movement of the guide robot 1 that accommodates for the path obstacle. The controller 5 appends the path correction into the intended geospatial path (Step I). Thus, the user is able to avoid the path obstacle concurrently with the guide robot 1. The guide robot 1 travels the intended geospatial path (Step J). Thus, the guide robot 1 is used to safely guide a visually impaired individual to a desired destination along the intended geospatial path.

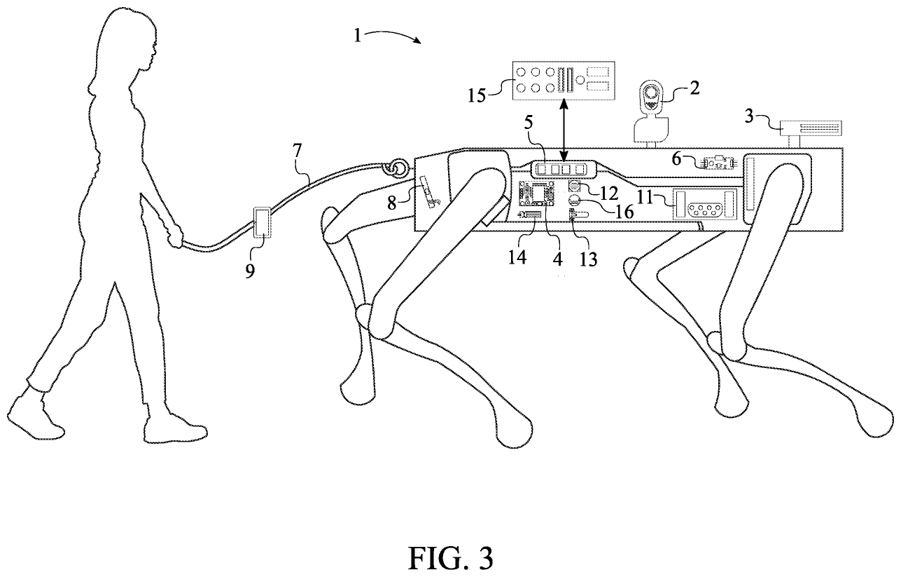

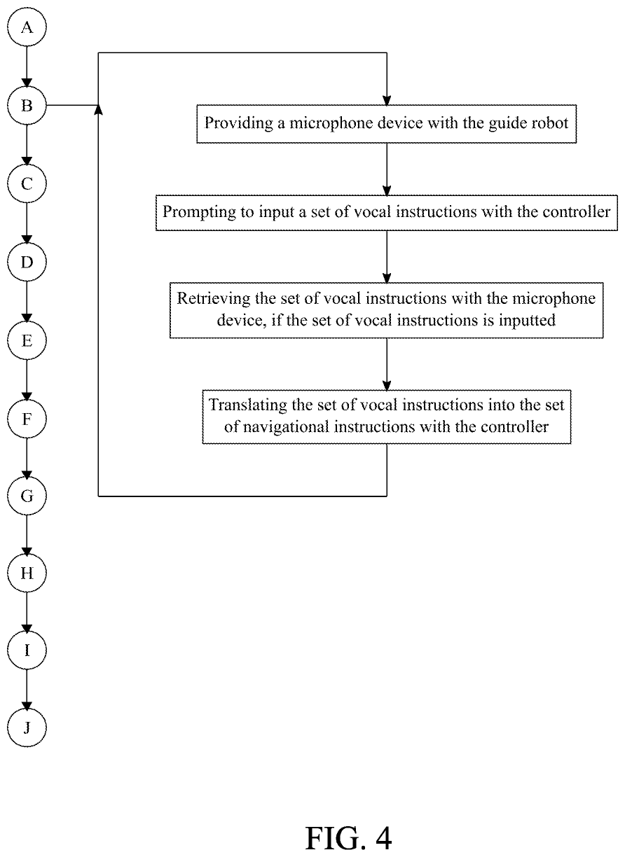

With reference to FIGS. 3 and 4, the following subprocess allows the user to input voice commands as the navigational instructions. A microphone device 6 is provided with the guide robot 1. The microphone device 6 is any device able to record sound. The controller 5 prompts to input a set of vocal instructions during Step B. The set of vocal instructions is a set of voice commands that audibly requests to travel to a desired destination and/or a set of voice commands to redirect the guide robot 1. The microphone device 6 retrieves the set of vocal instructions, if the set of vocal instructions is inputted. Thus, the guide robot 1 is provided with the set of vocal instructions. The controller 5 translates the set of vocal instructions into the set of navigational instructions. Thus, a user can direct the guide robot 1 to travel to a desired destination through voice commands.

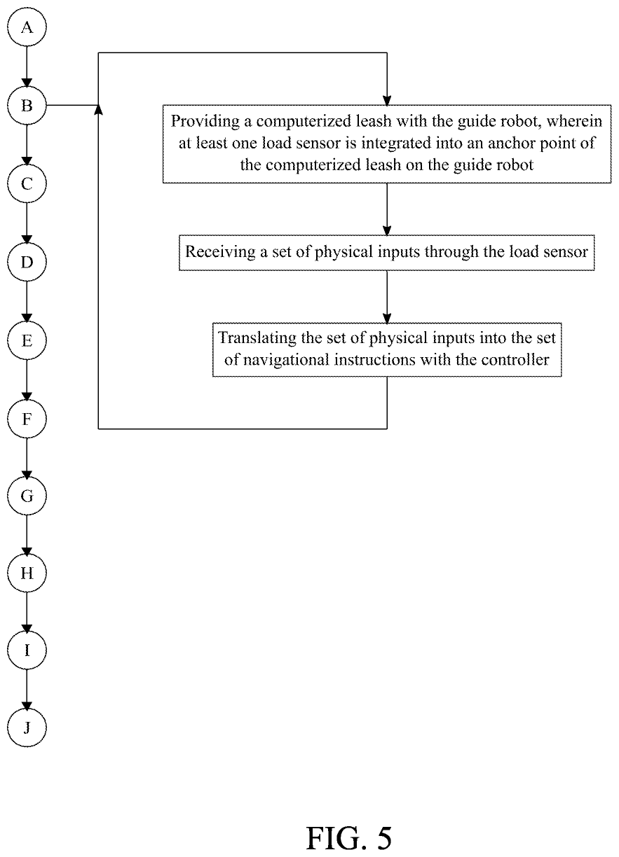

With reference to FIGS. 3 and 5, the following subprocess allows the user to remotely control the guide robot 1. A computerized leash 7 is provided with the guide robot 1. The computerized leash 7 is a tether that may be used to direct and control the guide robot 1. At least one load sensor 8 is integrated into an anchor point of the computerized leash 7 on the guide robot 1. The anchor point is where the computerized leash 7 is connected to the guide robot 1. The load sensor 8 is any device that can detect when the computerized leash 7 is being pulled and in what direction. The load sensor 8 retrieves a set of physical inputs during Step B. The set of physical inputs is whenever the user pulls on the computerized leash 7 in order to direct the guide robot 1. The controller 5 translates the set of physical inputs into the set of navigational instructions. Thus, a user can remotely control the guide robot 1 through the computerized leash 7.

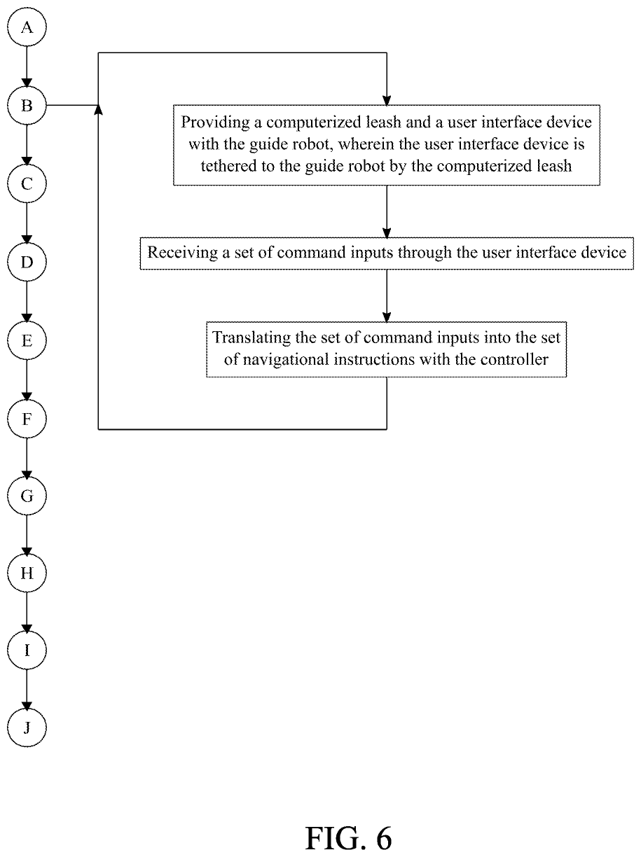

Alternatively and with reference to FIGS. 3 and 6, a user interface device 9 is provided with the guide robot 1 in order for the user to remotely control the guide robot 1. The user interface device 9 is tethered to the guide robot 1 by the computerized leash 7. The user interface device 9 is an interface such as, but not limited to, a touchscreen or a remote control with push buttons. The user interface retrieves a set of command inputs. The set of command inputs is used to direct the guide robot 1. The controller 5 translates the set of command inputs into the set of navigational instructions. Thus, a user can remotely control the guide robot 1 through the user interface device 9.

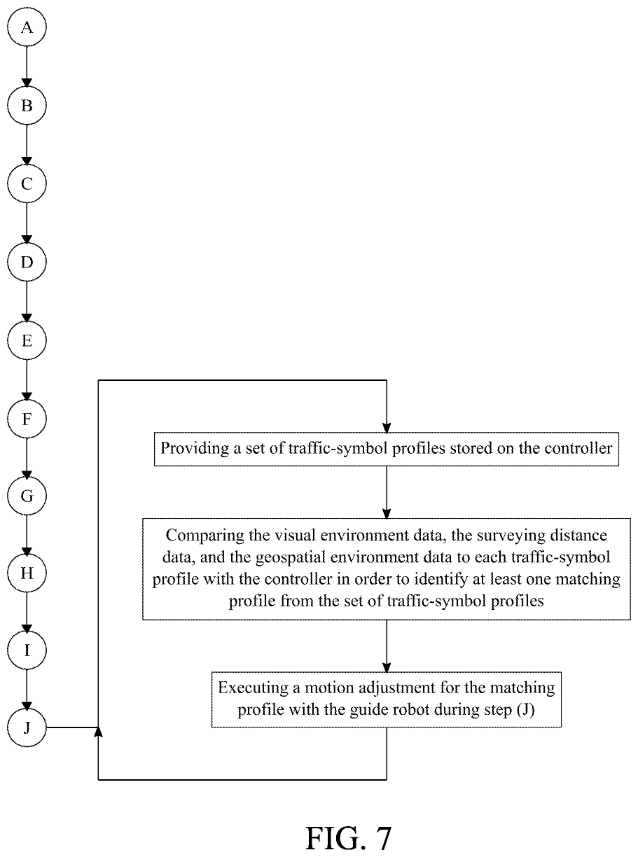

With reference to FIG. 7, the following subprocess allows the guide robot 1 to move dependent on traffic symbols. A set of traffic-symbol profiles is stored on the controller 5. The set of traffic-symbol profiles is a set of traffic symbol information including, but not limited to, traffic lights, pedestrian signals, and crosswalks. The controller 5 compares the visual environment data, the surveying distance data, and the geospatial environment data to each traffic-symbol profile in order to identify at least one matching profile from the set of traffic-symbol profiles. The matching profile is a traffic symbol that is detected when traveling the intended geospatial path. A motion adjustment is executed for the matching profile with the guide robot 1 during Step J. The motion adjustment is the appropriate reaction required based on the matching profile. For example, if a pedestrian signal is set to “Do not walk”, the robot guide will stop moving and therefore prevent the user from walking into incoming traffic.

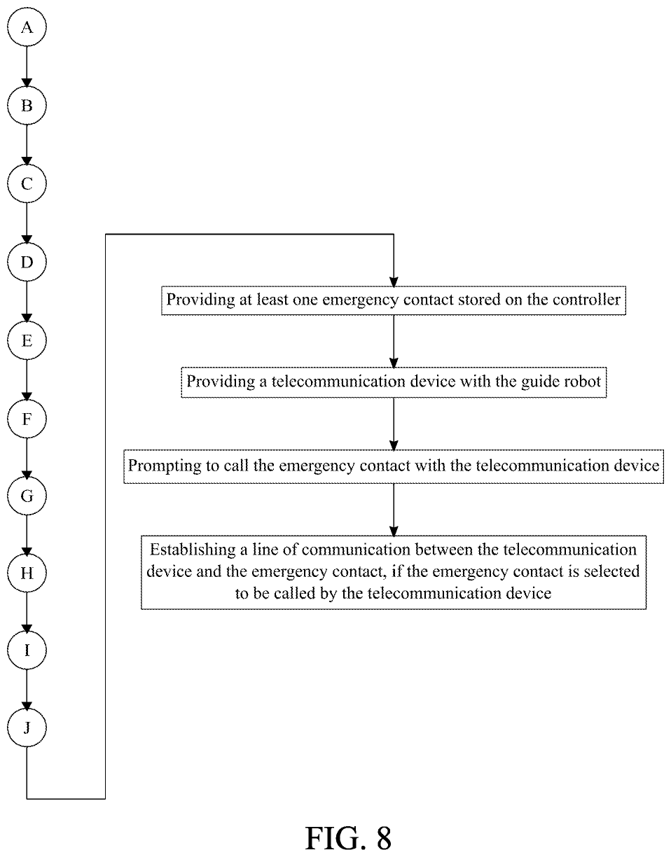

With reference to FIG. 8, the following subprocess allows the guide robot 1 to call an emergency contact in case of emergency. At least one emergency contact is stored on the controller 5, and a telecommunication device is provided with the guide robot 1. The emergency contact may be contact information for, but not limited, emergency services and/or personal emergency contacts. The telecommunication device is preferably a phone device able to communicate with another phone device. The telecommunication device prompts to communicate with the emergency contact. Alternatively, the telecommunication device may be used to prompt to send a text alert. A line of communication is established between the telecommunication device and the emergency contact, if the emergency contact is selected to communicate with the telecommunication device. Thus, the guide robot 1 is used to call an emergency contact in case of emergency. The location of the guide robot 1 can be sent to the emergency contact during this process and the guide robot 1 may prompt the user to activate an alarm.

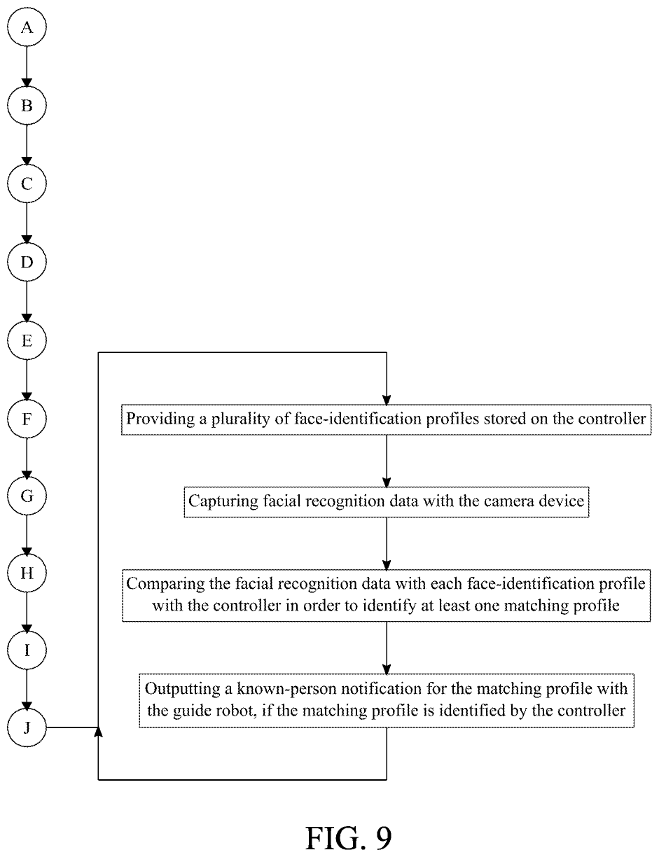

With reference to FIG. 9, the following subprocess notifies a user of a family member and/or friend detected by the guide robot 1. A plurality of face-identification profiles is stored on the controller 5. The plurality of face-identification profiles is set of profiles that includes facial identification data of family members and/or friends of the user. The camera device 2 captures facial recognition data. The facial recognition data is any facial data that is captured when traveling the intended geospatial path. The controller 5 compares the facial recognition data with each face-identification profile in order to identify at least one matching profile. The matching profile is a face-identification profile of a family member or friend of the user. The guide robot 1 outputs known-person notification for the matching profile, if the matching profile is identified by the controller 5. The known-person notification is preferably an audio notification that lets the user know a family member and/or friend has been detected by the guide robot 1.

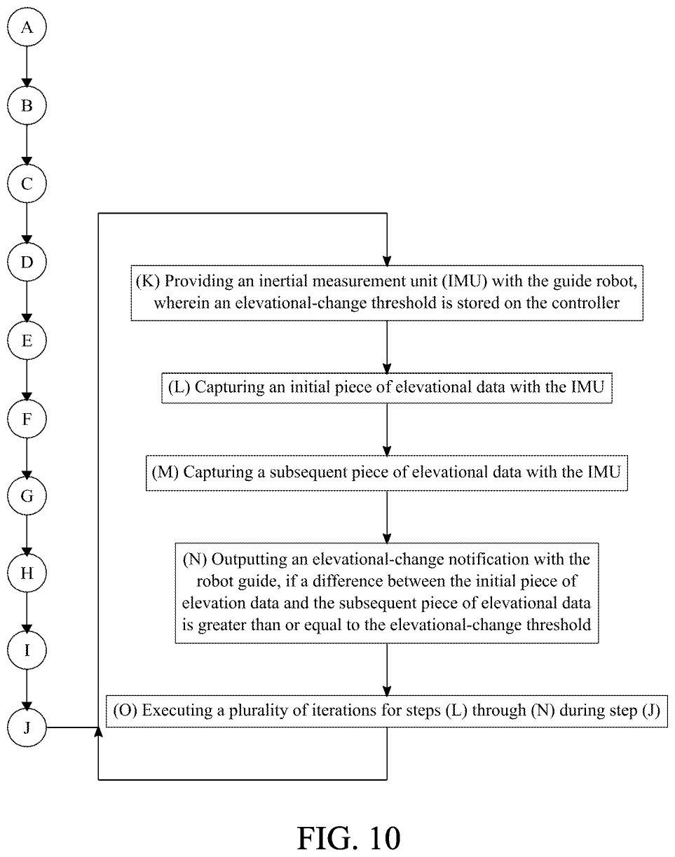

With reference to FIG. 10, the following subprocess notifies a user of elevational changes. An inertial measurement unit (IMU) 11 is provided with the guide robot 1 (Step K). The IMU 11 is a system which includes accelerometers and gyroscopes in order to measure movement and direction. An elevational-change threshold is also stored on the controller 5. The elevational-change threshold is an elevational change difference required to notify the user of an elevational change. The IMU 11 captures an initial piece of elevational data (Step L). The initial piece of elevational data is a first reading of the elevation trekked on by the guide robot 1. The IMU 11 then captures a subsequent piece of elevational data (Step M). The subsequent piece of elevational data is another reading of elevation trekked on by the guide robot 1. The guide robot 1 outputs an elevational-change notification, if a difference between the initial piece of elevational data and the subsequent piece of elevational data is greater than or equal to the elevational-change threshold (Step N). The elevational-change notification is a preferably an audio notification that lets the user know when there is a noticeable elevational change when traveling the intended geospatial path. A plurality of iterations is executed for Steps L through N during Step J (Step O). Thus, the guide robot 1 is continuously detecting for elevational changes in order to notify the user.

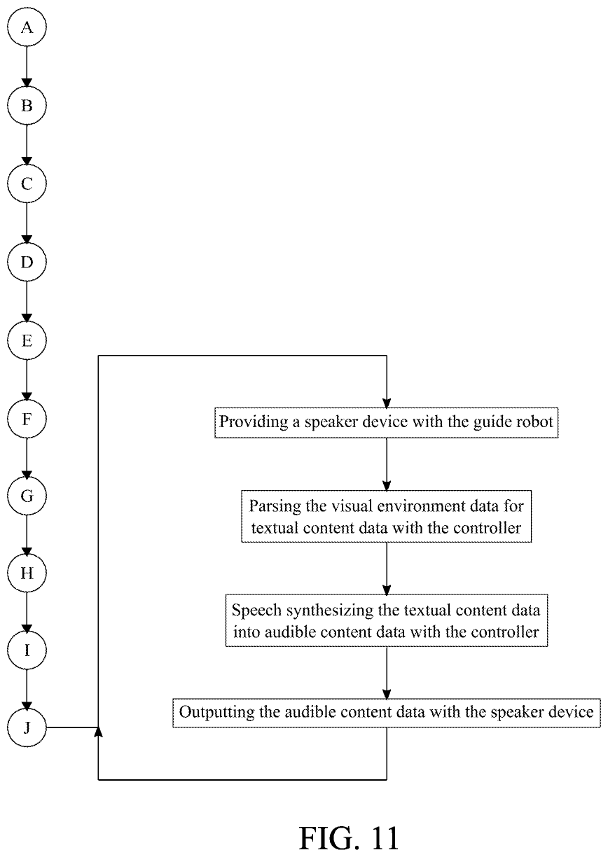

With reference to FIG. 11, the following subprocess notifies a user about informative signs and/or menus. A speaker device 12 is provided with the guide robot 1. The speaker device 12 is used to output audio to a user. The controller 5 parses the visual environment data for textual content data. The textual content data is preferably text data of street signs, restaurant signs or menus, and/or other signs/menus that are informative to the user. The controller 5 then uses speech synthesize the textual content data into audible content data. In further detail, the textual content data is converted into audible content data in order for a visually impaired individual to be informed of the textual content data. The speaker device 12 outputs the audible content data. Thus, the user is notified about information signs and/or menus. Additionally, the speaker device 12 is used to output other types of notifications that the guide robot 1 can output.

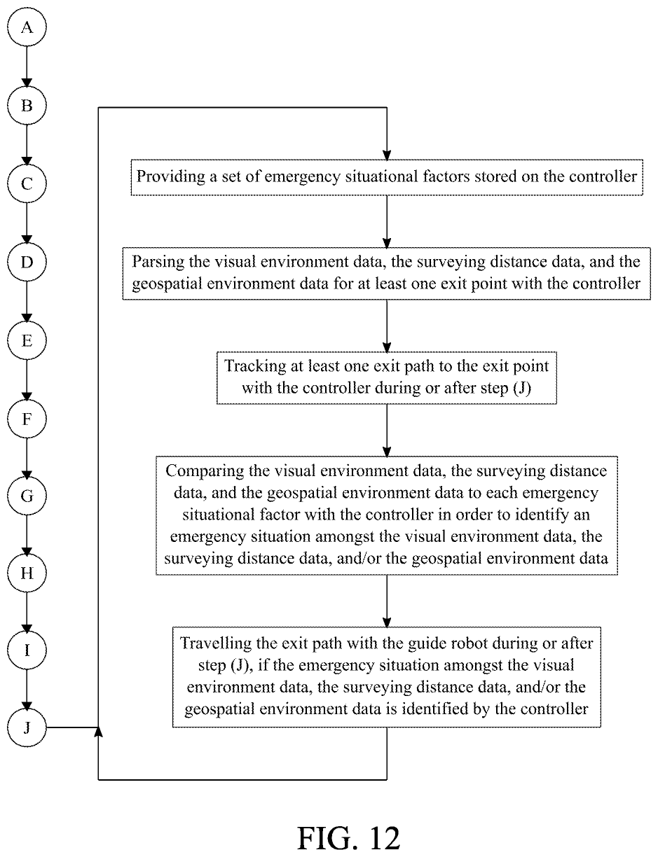

With reference to FIG. 12, the following subprocess plans an exit path for a user to travel in case of emergency. A set of emergency situational factors is stored on the controller 5. The set of emergency situational factors is a set of factors that signify an emergency such as, but not limited to, a fire alarm, police sirens, flooding water, smoke, or gunshots. The controller 5 parses the visual environment data, the surveying distance data, and the geospatial environment data for at least one exit point. The exit point is any exit that is available when traveling the intended geospatial path. The controller 5 tracks at least one exit path to the exit point during or after Step J. The exit path is a virtual path that leads to the exit point. The controller 5 compares the visual environment data, the surveying distance data, and the geospatial environment data to each emergency situational factor in order to identify an emergency situation amongst the visual environment data, the surveying distance data, and/or the geospatial environment data. The emergency situation may be any type of emergency such as, but not limited to, a fire, a flood, or an armed robbery. The guide robot 1 travels the exit path during or after Step J, if the emergency situation amongst the visual environment data, the surveying distance data, and/or the geospatial environment data is identified by the controller 5. Thus, the user is able to travel an exit path with the guide robot 1 in case of emergency.

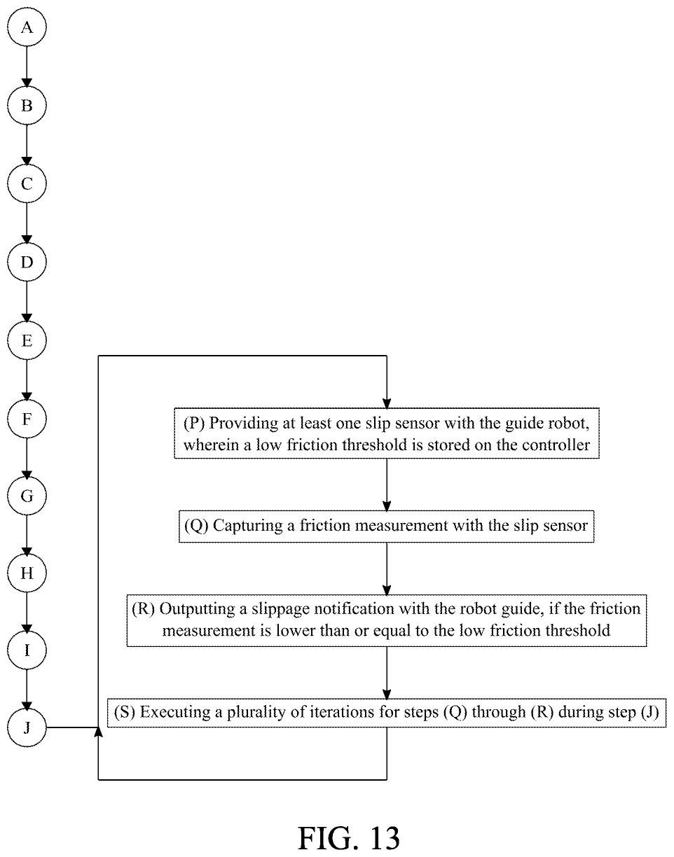

With reference to FIG. 13, the following subprocess notifies a user about a slippery surface. At least one slip sensor 13 is provided with the guide robot 1 (Step P). The slip sensor 13 determines coefficient of frictions of various surfaces. A low friction threshold is stored on the controller 5. The low friction threshold is the required friction value used to determine if a surface is slippery. The slip sensor 13 captures friction measurement (Step Q). The friction measurement is a coefficient of friction of a particular surface. The guide robot 1 outputs a slippage notification, if the friction measurement is lower than or equal to the low friction threshold (Step R). The slippage notification is preferably an audible notification that lets a user know that a slippery surface is ahead. A plurality of iterations is executed for Steps Q through R during step J (Step S). Thus, the guide robot 1 is continuously detecting for slippery surfaces in order to notify the user.

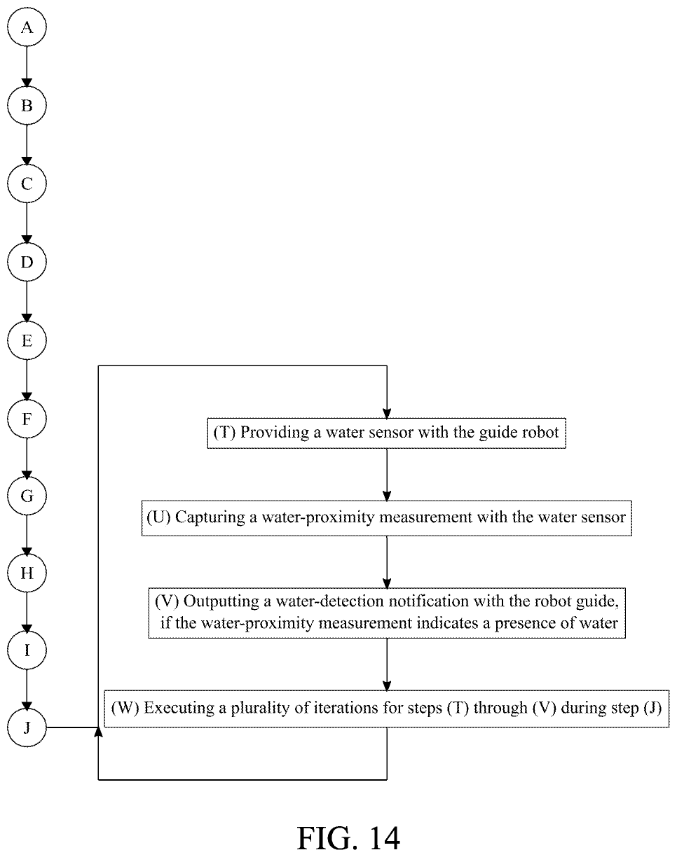

With reference to FIG. 14, the following subprocess notifies a user when there is water present. For example, the following subprocess notifies the user of puddles of water or similar along the intended geospatial path in order to avoid areas with water. At least one water sensor 14 is provided with the guide robot 1 (Step T). The water sensor 14 is used to determine if water is present. The water sensor 14 is used to capture a water-proximity measurement (Step U). The water-proximity measurement is a live reading of the water levels in the area surrounding the guide robot 1. The guide robot 1 is used to output a water-detection notification, if the water-proximity measurement indicates a presence of water (Step V). The water-detection notification is preferably an audible notification that lets a user know that water is present near the surrounding area. A plurality of iterations is executed for Steps T through V during step J (Step W). Thus, the guide robot 1 is continuously detecting for the presence of water in order to identify the user.

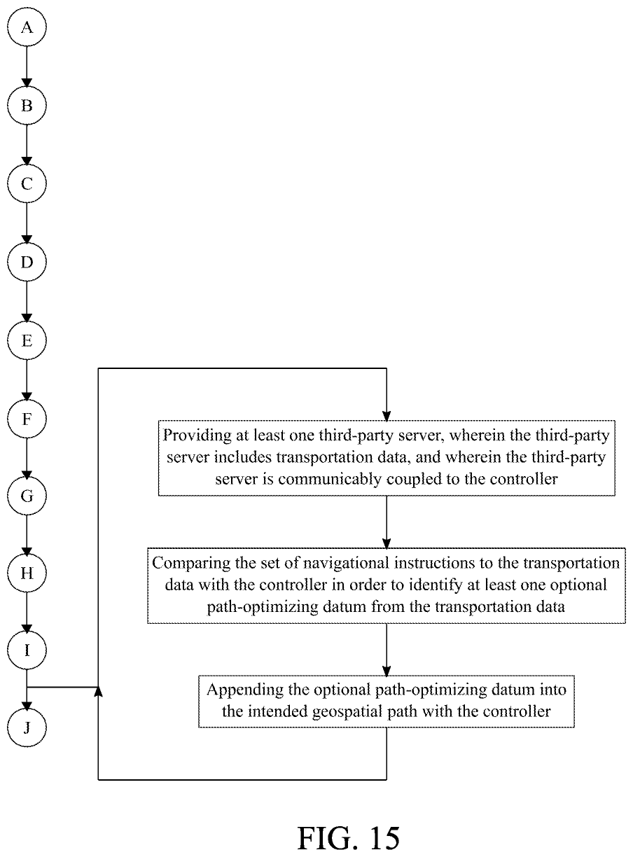

With reference to FIG. 15, the following subprocess is used to gather public transportation data in order to optimize the intended geospatial path. At least one third-party server 15 is provided for the present invention. The third-party server 15 is a server belonging to various types of public transportation services. The third-party server 15 includes transportation data. The transportation data includes, but is not limited to, times and prices of transportation services. The third-party server 15 is communicably coupled to the controller 5 in order to communicate the transportation data with the controller 5. The controller 5 compares the set of navigational instructions to the transportation data in order to identify at least one optional path-optimizing datum from the transportation data. The optional path-optimizing datum is transportation information that is useful in optimizing the intended geospatial path. For example, transportation data such as public bus info that allows the user to quickly reach the desired destination. The controller 5 appends the optional path-optimizing datum into the intended geospatial path. Thus, the intended geospatial path is optimized by transportation data.

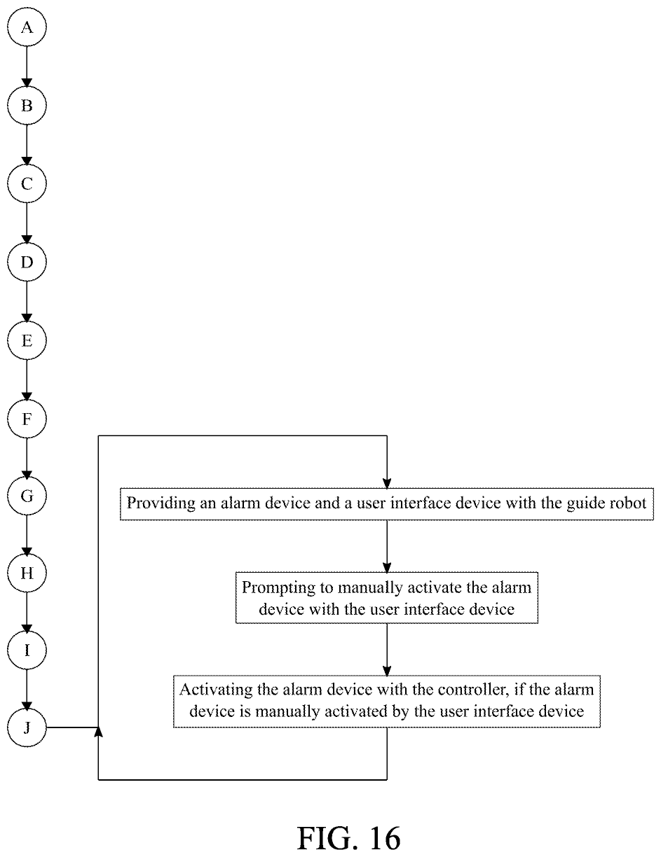

With reference to FIG. 16, the following subprocess allows a user to activate an alarm in case of emergency. For example, the guide robot 1 or user can sound off an alarm when the user needs help. An alarm device 16 and the user interface device 9 is provided with the guide robot 1. The alarm device 16 may be any type of alarm such as, but not limited to, a sound alarm, a light alarm, or a combination thereof. The user interface device 9 prompts to manually activate the alarm device 16. This step provides the user with the option to activate the alarm device 16. The controller 5 activates the alarm device 16, if the alarm device 16 is manually activated by the user interface device 9. Thus, the user can activate the alarm device 16 in case of emergency. Moreover, the emergency contact may be notified when the alarm device 16 is activated.

In another embodiment, the following subprocess allows the robot guide to grow more efficient in avoiding or overcoming path obstacles. A plurality of obstacle images is stored on the controller 5. The plurality of obstacle images is a set of images which includes a variety of obstacles that are possible to encounter along the intended geospatial path. The controller 5 is used to compare the visual environment data, the surveying distance data, and the geospatial environment data to each obstacle image in order to identify the at least one path obstacle. If the path obstacle is matched to an obstacle image, the controller 5 does not append the encountered path obstacle into the plurality of obstacle images. If the path obstacle is not matched to an obstacle image, the controller 5 is used to append the path obstacle into the plurality of obstacles images. Thus, the guide robot 1 uses machine learning in order to efficiently avoid or overcome path obstacles that may be encountered along the intended geospatial path.

In another embodiment of the present invention, the microphone device 6 and the speaker device 12 is provided as a wireless headset. The notifications that the guide robot 1 outputs are directly communicated to a user through the wireless headset. Moreover, the user is able to give voice commands directly through the wireless headset.

Although the invention has been explained in relation to its preferred embodiment, it is to be understood that many other possible modifications and variations can be made without departing from the spirit and scope of the invention as hereinafter claimed.

1. A method for assisting a visually impaired individual, the method comprises the steps of:
(A) providing a guide robot and a computerized leash with the guide robot, wherein the guide robot comprises at least one camera device, at least one distance measurement device, a global positioning system (GPS) module, and a controller, wherein at least one load sensor is integrated into an anchor point of the computerized leash on the guide robot, wherein the anchor point is where the computerized leash is connected to the guide robot;
(B) receiving a set of physical inputs through the load sensor, translating the set of physical inputs into a set of navigational instructions with the controller and retrieving the set of navigational instructions with the controller, wherein the set of physical inputs is whenever the visually impaired individual pulls on the computerized leash in order to direct the guide robot;
(C) compiling the set of navigational instructions into an intended geospatial path with the controller;
(D) capturing visual environment data with the camera device;
(E) capturing surveying distance data with the distance measurement device;
(F) capturing geospatial environment data with the GPS module;
(G) comparing the intended geospatial path amongst the visual environment data, the surveying distance data, and the geospatial environment data with the controller in order to identify at least one path obstacle in the intended geo spatial path;
(H) generating at least one path correction with the controller in order to avoid the path obstacle along the intended geospatial path;
(I) appending the path correction into the intended geospatial path with the controller;
(J) travelling the intended geospatial path with the guide robot;
(K) providing an inertial measurement unit (IMU) with the guide robot, wherein an elevational-change threshold is stored on the controller, wherein the IMU is a gyroscope;
(L) capturing an initial piece of elevational data with the IMU;
(M) capturing a subsequent piece of elevational data with the IMU;
(N) outputting an elevational-change notification with the robot guide, if a difference between the initial piece of elevation data and the subsequent piece of elevational data is greater than or equal to the elevational-change threshold; and
(O) executing a plurality of iterations for steps (L) through (N) during step (J).

2. The method for assisting a visually impaired individual, the method as claimed in claim 1 comprises the steps of:
providing a microphone device with the guide robot;
prompting to input a set of vocal instructions with the controller during step (B);
retrieving the set of vocal instructions with the microphone device, if the set of vocal instructions is inputted; and
translating the set of vocal instructions into the set of navigational instructions with the controller.

3. (canceled)

4. The method for assisting a visually impaired individual, the method as claimed in claim 1 comprises the steps of:
providing the computerized leash and a user interface device with the guide robot, wherein the user interface device is tethered to the guide robot by the computerized leash;
receiving a set of command inputs through the user interface device; and
translating the set of command inputs into the set of navigational instructions with the controller.

5. The method for assisting a visually impaired individual, the method as claimed in claim 1 comprises the steps of:
providing a set of traffic-symbol profiles stored on the controller;
comparing the visual environment data, the surveying distance data, and the geospatial environment data to each traffic-symbol profile with the controller in order to identify at least one matching profile from the set of traffic-symbol profiles; and
executing a motion adjustment for the matching profile with the guide robot during step (J).

6. The method for assisting a visually impaired individual, the method as claimed in claim 1 comprises the steps of:
providing at least one emergency contact stored on the controller;
providing a telecommunication device with the guide robot;
prompting to communicate with the emergency contact with the telecommunication device; and
establishing a line of communication between the telecommunication device and the emergency contact, if the emergency contact is selected to communicate with the telecommunication device.

7. The method for assisting a visually impaired individual, the method as claimed in claim 1 comprises the steps of:
providing a plurality of face-identification profiles stored on the controller;
capturing facial recognition data with the camera device;
comparing the facial recognition data with each face-identification profile with the controller in order to identify at least one matching profile; and
outputting a known-person notification for the matching profile with the guide robot, if the matching profile is identified by the controller.

8. (canceled)

9. The method for assisting a visually impaired individual, the method as claimed in claim 1 comprises the steps of:
providing a speaker device with the guide robot;
parsing the visual environment data for textual content data with the controller;
speech synthesizing the textual content data into audible content data with the controller; and
outputting the audible content data with the speaker device.

10. The method for assisting a visually impaired individual, the method as claimed in claim 1 comprises the steps of:
providing a set of emergency situational factors stored on the controller;
parsing the visual environment data, the surveying distance data, and the geospatial environment data for at least one exit point with the controller;
tracking at least one exit path to the exit point with the controller during or after step (J);
comparing the visual environment data, the surveying distance data, and the geospatial environment data to each emergency situational factor with the controller in order to identify an emergency situation amongst the visual environment data, the surveying distance data, and/or the geospatial environment data; and
travelling the exit path with the guide robot during or after step (J), if the emergency situation amongst the visual environment data, the surveying distance data, and/or the geospatial environment data is identified by the controller.

11. The method for assisting a visually impaired individual, the method as claimed in claim 1 comprises the steps of:
(P) providing at least one slip sensor with the guide robot, wherein a low friction threshold is stored on the controller;
(Q) capturing a friction measurement with the slip sensor;
(R) outputting a slippage notification with the robot guide, if the friction measurement is lower than or equal to the low friction threshold; and
(S) executing a plurality of iterations for steps (Q) through (R) during step (J).

12. The method for assisting a visually impaired individual, the method as claimed in claim 1 comprises the steps of:
(T) providing at least one water sensor with the guide robot;
(U) capturing a water-proximity measurement with the water sensor;
(V) outputting a water-detection notification with the robot guide, if the water-proximity measurement indicates a presence of water; and
(W) executing a plurality of iterations for steps (T) through (V) during step (J).

13. The method for assisting a visually impaired individual, the method as claimed in claim 1 comprises the steps of:
providing at least one third-party server, wherein the third-party server includes transportation data, and wherein the third-party server is communicably coupled to the controller;
comparing the set of navigational instructions to the transportation data with the controller in order to identify at least one optional path-optimizing datum from the transportation data; and
appending the optional path-optimizing datum into the intended geospatial path with the controller.

14. The method for assisting a visually impaired individual, the method as claimed in claim 1 comprises the steps of:
providing an alarm device and a user interface device with the guide robot;
prompting to manually activate the alarm device with the user interface device; and
activating the alarm device with the controller, if the alarm device is manually activated by the user interface device.
